(19) United States
(12) Patent Application Publication
(10) Pub. No.: US 2005/0110385 A1
(43) Pub. Date: May 26, 2005

(54) Color cathode ray tube

(76) Inventors: Sang Yoon Park, Gumi-si (KR); Jong Eon Choi, Gumi-si (KR); Pyeong Soo Jeong, Daegukwangyeok-si (KR)

Correspondence Address: BIRCH STEWART KOLASCH & BIRCH, PO BOX 747, FALLS CHURCH, VA, 22040-0747, US

(21) Appl. No.: 10/843,436

(22) Filed: May 12, 2004

(30) Foreign Application Priority Data
Nov. 20, 2003 (KR) 10-2003-0082792

(51) Int. Cl. H01J 29/80

(52) U.S. Cl. 313/402

(57) ABSTRACT

A color cathode ray tube in which beam landing errors caused by non-uniform thermal expansion of a shadow mask and the terrestrial magnetism are corrected is provided such that color purity is improved. The color cathode ray tube in accordance with the present invention comprises a panel having a phosphor screen formed on an inner surface thereof, a shadow mask having a faceplate portion and a peripheral skirt portion bent back from the faceplate portion and a frame joined to the skirt portion of the shadow mask is provided, wherein height of the skirt portion at a long side of the faceplate portion is different from height of the skirt portion at a short side of the faceplate portion, and a plurality of holes are perforated at the skirt portion of a short side of the faceplate portion.

This Nonprovisional application claims priority under 35 U.S.C. § 119(a) on Patent Application No. 10-2003-82792 filed in Korea on Nov. 20, 2003, the entire contents of which are hereby incorporated by reference.

### BACKGROUND OF THE INVENTION

1. Field of the Invention

The present invention relates to a color cathode ray tube and more specifically to a color cathode ray tube in which beam landing errors caused by non-uniform thermal expansion of a shadow mask are corrected such that color purity is improved.

2. Description of the Background Art

FIG. 1 shows a schematic diagram illustrating the structure of a general color cathode ray tube of the background art. As shown in FIG. 1, the color cathode ray tube generally includes a glass envelope having a shape of bulb and is comprised of a faceplate panel 10, a tubular neck 120, and a funnel 20 connecting the panel 10 and the neck 120.

The panel 10 comprises a faceplate portion and a peripheral sidewall portion sealed to the funnel 20. A phosphor screen 30 is formed on the inner surface of the faceplate portion. The phosphor screen 30 is coated by phosphor materials of R, G, and B. A multi-apertured color selection electrode, i.e., shadow mask 40 is mounted to the screen with a predetermined space. The shadow mask 40 is supported by a peripheral frame 70. An electron gun 50 is mounted within the neck to generate and direct electron beams 60 along paths through the mask to the screen.

The shadow mask 40 and the frame 70 constitute a mask-frame assembly. The mask-frame assembly is joined to the panel 10 by means of springs 80.

The cathode ray tube further comprises an inner shield 90 for shielding the tube from external geomagnetism, a reinforcing band 100 attached to the sidewall portion of the panel 10 to prevent the cathode ray tube from being exploded by external shock, and external deflection yoke 110 located in the vicinity of the funnel-to-neck junction.

The electron beams generated by the electron gun are deflected in either vertical or horizontal directions by the deflection yoke 110. The electron beams are selected by the shadow mask depending on the colors and impinge on the phosphor screen such that the phosphor screen emits light in different colors. Typically, about 80% of the electrons from the electron gun 50 fail to pass through the apertures of the shadow mask 40. The 80% of electrons impinge upon the shadow mask 40, producing heat and raising the temperature of the mask 40.

FIG. 2 shows a perspective view of a lower right quarter of a shadow mask illustrating thermal distribution of the surface of the mask due to the impingement of electrons. As shown in FIG. 2, the temperature of the mask is different for different portions of the mask. In FIG. 2, a center portion of the mask has a higher temperature than a corner portion. The reason why the corner portion has a lower temperature is that the heat at the corner portion is dissipated through the frame attached to the mask. Since the frame is attached to the mask at the skirt portion near the corner, heat at the corner is easily transferred to the outside via the frame. Because the mask is thermally expanded, a position of the apertures at the shadow mask is shifted from the desired position accordingly. Therefore, electron beams passing through the apertures land at the screen incorrectly. In this way the color purity at the screen is degraded. This phenomenon of purity degradation resulting from the undesired positional shift of the apertures of the mask is called the “doming effect.”

FIG. 3a shows a cross-sectional view of the shadow mask for illustrating purity degradation resulting from the positional shift of the apertures of the shadow mask 40. FIG. 3b is a graph showing the extent of variation in the positional shift of electrons landing incorrectly at the screen with respect to time when the cathode ray tube is placed in operation.

As shown in FIG. 3a, an electron beam landing at the screen is shifted due to the positional shift of the apertures of the shadow mask. As shown in FIG. 3b, the extent of the shift of the electron beam landing at the screen increases just after the cathode ray tube is operated, since the temperature of the shadow mask begins to increase. However, as the heat at the shadow mask is transferred to the frame, the frame is heated and expanded. Accordingly, the positional shift of the electron landing is decreased. As the heat dissipation through the frame continues, the landing position of the electron beam is displaced in the opposite direction with respect to the initial shift, which occurs just after the initial operation of the shadow mask.

The variation in the shift of the electron beam landing causes degradation of color purity. Further, since the landing position varies in accordance with the time after the shadow mask is operated, restoration of the aperture position with respect to the screen is difficult.

FIG. 4 is a perspective view of the conventional shadow mask. The conventional shadow mask comprises a central apertured portion 41 through which electron beams pass, a non-apertured border portion 42 surrounding the apertured portion 41, and a peripheral skirt portion 43 bent back from the border portion 42 and extending backward from the apertured portion 41. As shown in FIG. 4, the border portion 42 and the skirt portion 43 have more area than is necessary in view of the function they perform. The large area of the border portion 42 and the skirt portion 43 increases the non-uniformity of thermal expansion across the shadow mask. Therefore, the conventional shadow mask suffers from color purity degradation caused by the doming effect.

Moreover, the welding point between the shadow mask and the frame intensifies the non-uniformity of the thermal expansion. Typically, the shadow mask is fixed to the frame by welding through a plurality of welding points 43a. When the shadow mask expands thermally due to the beam radiation, the welding points become binding points against the expansion of the shadow mask. Therefore, the non-uniformity of expansion of the shadow mask is increased, thereby increasing a landing error of the electron beams.

In order to prevent or lessen the doming effect caused by a landing error of the electron beams, many different approaches have been used.

First, structural improvements of the shadow mask have been suggested in order to prevent the landing error problem. According to Japanese Laid-Open Patent Publication No. S62-177831, a temperature control device is provided within the cathode ray tube in order to suppress the temperature elevation of the mask. Also, according to Japanese Laid-Open Patent Publication No. H6-267446, a reinforcement member for maintaining the shape of the shadow mask is provided between the shadow mask and the frame. However, the landing error problem was not solved by those structural approaches.

Also, improvement in the material used for the shadow mask was suggested. Invar material having a low thermal expansion rate was used for the shadow mask instead of aluminum killed (AK) material. However, the result of using the invar material was not satisfactory in view of the price of the material.

Finally, there have been many approaches to solve landing errors caused by spring back phenomenon. Spring back phenomenon occurs when the shadow mask is manufactured by a forming process. When a forming process is used in making a shadow mask, a shadow mask is formed by pressing to have a shape comprising a central portion and a skirt portion bent back from the central portion 41 and extending backward. Then, the shadow mask is fixed to a frame. After the mask-frame assembly is made, the skirt portion of the shadow mask tends to move outward from the center by a resilient force. This is called spring back phenomenon. This spring back phenomenon is one of the causes of the landing error problem.

As a solution for solving the landing error problem due to the spring back phenomenon, an idea of making the border portion of the shadow mask to be partially thinner than the central portion was suggested in Japanese Laid-Open Patent Publication No. S49-112566. Additionally, according to Japanese Laid-Open Patent Publication No. S63-271849, protrusions are provided, which are protruded from a skirt portion of a shadow mask backward from a central portion. According to Japanese Laid-Open Patent Publication No. H1-169847, many openings are perforated in the skirt portion for absorbing compression stress. However, those techniques are directed to solving the landing error problem caused by the spring back phenomenon. Therefore, those techniques are not sufficient to solve the problem due to the non-uniform thermal expansion of the shadow mask.

Further, when the cathode ray tube is placed in the presence of a terrestrial magnetism, the terrestrial magnetism causes the electron beam not to strike a desired position of the phosphor screen. Accordingly, the terrestrial magnetism also deteriorates color purity of the cathode ray tube.

In order to prevent the electron beam from being deflected by the terrestrial magnetism, an inner shield 90 of magnetic shielding material is provided. In general, the inner shield 90 is fixed to the mask-frame assembly such that the inner shield 90 and the shadow-mask is mounted within the glass envelope of the cathode ray tube.

Even when the inner shield 90 is provided, the deflection of the electron beam caused by the terrestrial magnetism cannot be completely suppressed. This is because certain portion within the panel 10 is not shielded by such inner shield 90. One of such portion which is not shielded by the inner shield 90 is the area corresponding to the minor sides of the panel 10. The electron beams passing through such area is deflected by the terrestrial magnetism.

Many approaches have been suggested to prevent these problems. Korean Laid-open Patent Publication No. 2002-88217 introduces a cathode ray tube where separate inner shield is additionally provided for the area which is not shielded by the conventional inner shield 90. However, this approach could not effectively reduce the landing error caused by the terrestrial magnetism.

### SUMMARY OF THE INVENTION

Accordingly, an object of the present invention is to solve at least the problems and disadvantages of the background art.

An object of the present invention is to provide a color cathode ray tube in which a landing error problem causing degradation of color purity is prevented.

Another object of the present invention is to provide a color cathode ray tube in which non-uniform thermal expansion of the shadow mask is avoided such that color purity is improved.

A further object of the present invention is to provide a color cathode ray tube in which the influence of the welding point between the shadow mask and frame upon thermal expansion of the shadow mask is minimized such that color purity is improved.

According to an aspect of the present invention, a color cathode ray tube comprising a panel having a phosphor screen formed on an inner surface thereof, a shadow mask having a faceplate portion and a peripheral skirt portion bent back from the faceplate portion and a frame joined to the skirt portion of the shadow mask is provided, wherein height of the skirt portion at a long side of the faceplate portion is different from height of the skirt portion at a short side of the faceplate portion, and a plurality of holes are perforated at the skirt portion of a short side of the faceplate portion.

According to another aspect of the present invention, a color cathode ray tube comprising a panel having a phosphor screen formed on an inner surface thereof, a shadow mask having a faceplate portion and a peripheral skirt portion bent back from the faceplate portion and a frame joined to the skirt portion of the shadow mask is provided, wherein height of the skirt portion is less than or equal to 12 mm for substantially entire skirt portion, and a plurality of holes are perforated at the skirt portion of a short side of the faceplate portion.

### BRIEF DESCRIPTION OF THE DRAWINGS

The invention will be described in detail with reference to the following drawings in which like numerals refer to like elements.

FIG. 1 shows a schematic diagram illustrating the structure of a general color cathode ray tube of the background art.

FIG. 2 shows a perspective view of a lower right quarter of a shadow mask illustrating thermal distribution of the surface of the mask due to the impingement of electrons.

FIG. 3a shows cross-sectional view of the shadow mask for illustrating purity degradation resulting from the positional shift of the apertures of the shadow mask.

FIG. 3b shows a graph depicting variation in an amount of positional shift of electrons landing incorrectly at the screen with respect to time after the cathode ray tube is placed into operation.

FIG. 4 shows a perspective view of a shadow mask of the background art.

FIG. 5a shows a perspective view of a shadow mask in accordance with an embodiment of the present invention.

FIG. 5b shows a plane view of the shadow mask in accordance with an embodiment of the present invention.

FIGS. 6a and 6b show a side view of a mask-frame assembly to illustrate an example of the relatively long and short skirt portions respectively.

FIG. 6c shows an example of a skirt portion having a protrusion.

FIG. 7 shows a graph illustrating the result of Table 1.

FIG. 8 shows a side view of the shadow mask in accordance with a modified version of an embodiment of the present invention.

FIG. 9 shows a perspective view of a shadow mask in accordance with another embodiment of the present invention.

### DETAILED DESCRIPTION OF PREFERRED EMBODIMENTS

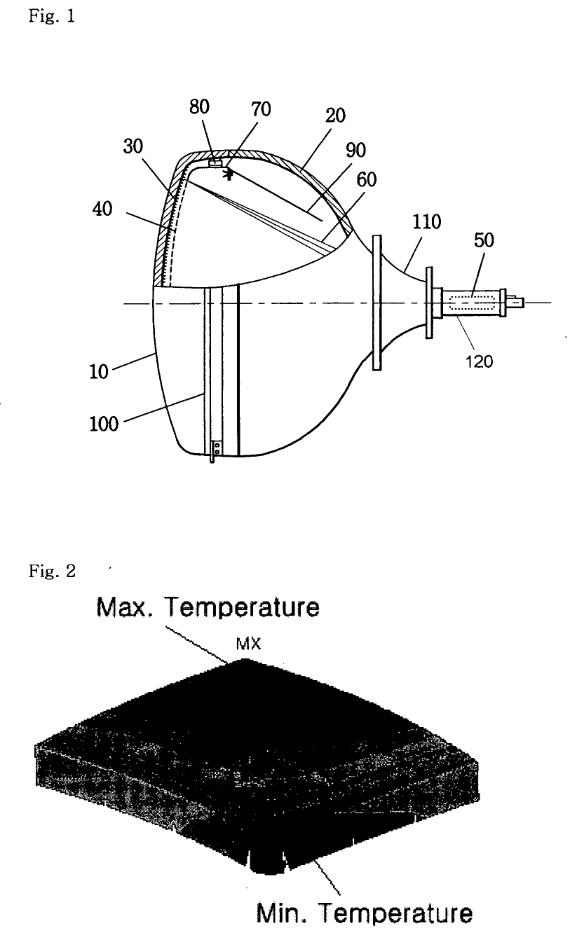

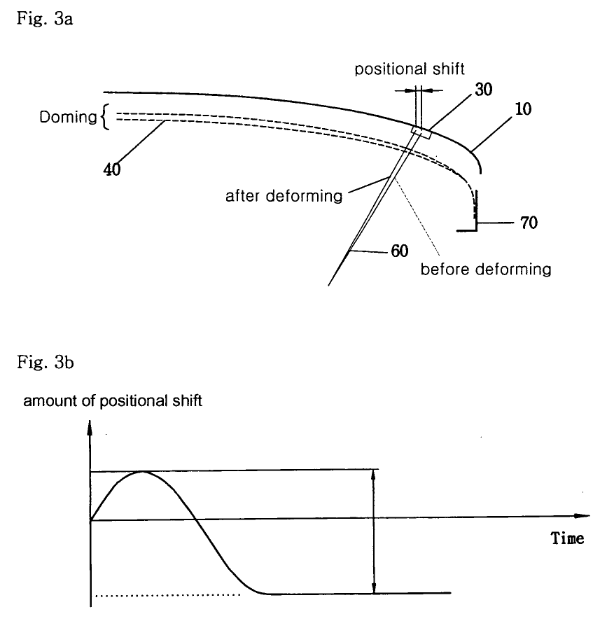

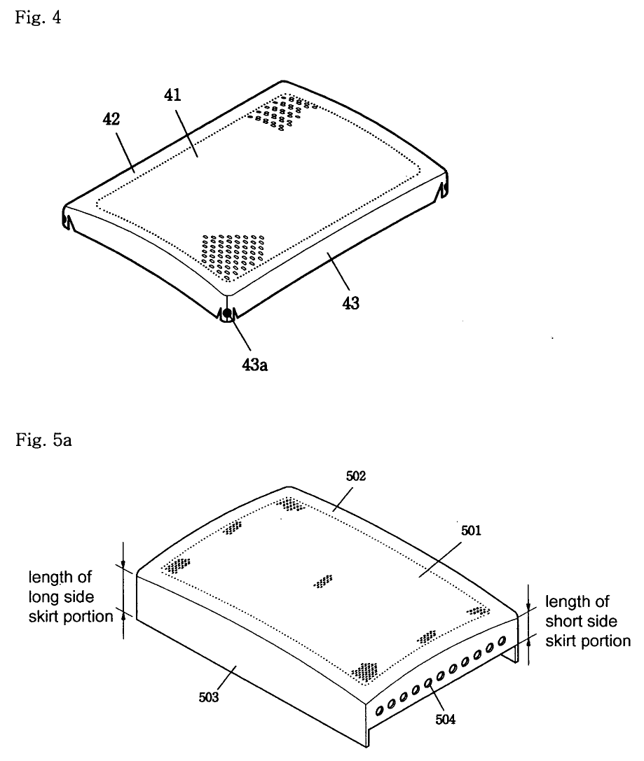

Preferred embodiments of the present invention will be described in a more detailed manner with reference to the drawings. The embodiments may be implemented in the device shown in FIG. 1.

### First Embodiment

According to an aspect of the present invention, a color cathode ray tube comprising a panel having a phosphor screen formed on an inner surface thereof, a shadow mask having a faceplate portion and a peripheral skirt portion bent back from the faceplate portion and a frame joined to the skirt portion of the shadow mask is provided, wherein height of the skirt portion at a long side of the faceplate portion is different from height of the skirt portion at a short side of the faceplate portion, and a plurality of holes are perforated at the skirt portion of a short side of the faceplate portion.

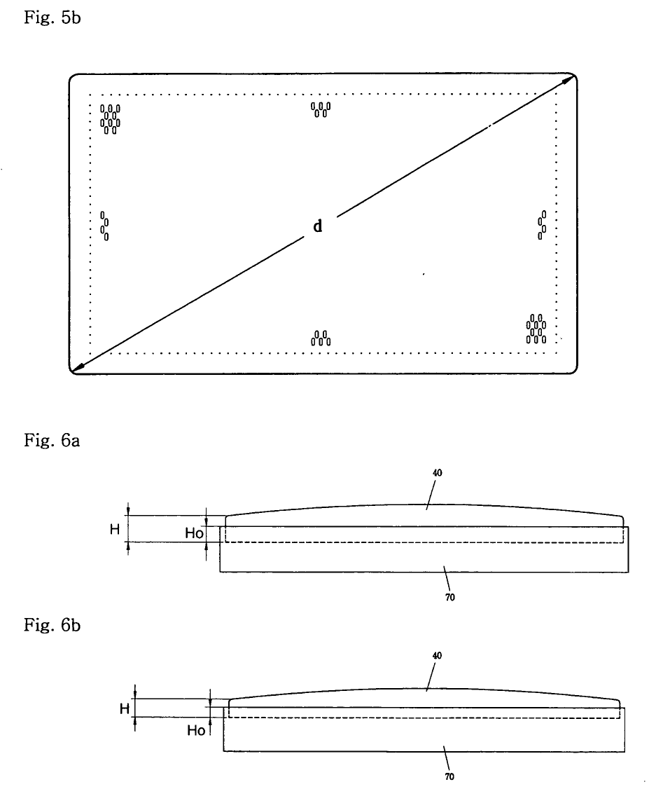

FIG. 5a shows a perspective view of a shadow mask in accordance with a preferred embodiment of the present invention.

As shown in FIG. 5a, the shadow mask in accordance with this embodiment of the present invention comprises a faceplate portion and a peripheral skirt portion bent back from the faceplate portion and extending backward from the faceplate portion. The faceplate portion further comprises an apertured portion 501 where minute apertures through which electron beams pass are defined and a non-apertured border portion 502 surrounding the apertured portion 501. The skirt portion comprises long side skirt portion 503 and short side skirt portion 504 which are provided peripheral to the long side and short side of the faceplate portion, respectively.

According to this embodiment, by making the heights of the skirt portions at the long side 503 and the short side 504 to be different from each other, and perforating a plurality of holes only at the short side skirt portion 504, landing error caused by the terrestrial magnetism is reduced. Since a plurality of holes are perforated at the short side skirt portion 504, heat transfer between the skirt portion 504 and the frame is minimized. Accordingly, non-uniformity of thermal expansion between the central and peripheral portions in the shadow mask is decreased such that landing error of electron beam caused by the non-uniformity of expansion is decreased.

Along the shot side of the shadow mask, a plurality of holes are perforated so as to reduce landing errors caused by the non-uniform thermal expansion of the shadow mask. Along the long side, height of the skirt portion is different from that of the skirt portion at the short side and, at the same time, hole is not perforated at the long side skirt portion, such that landing errors due to the terrestrial magnetism are reduced.

Additionally, height of the long side skirt portion is made to be greater than that of the shot side skirt portion. In this way, the effect of the terrestrial magnetism may further be reduced. This is a modified version of this embodiment of the present invention.

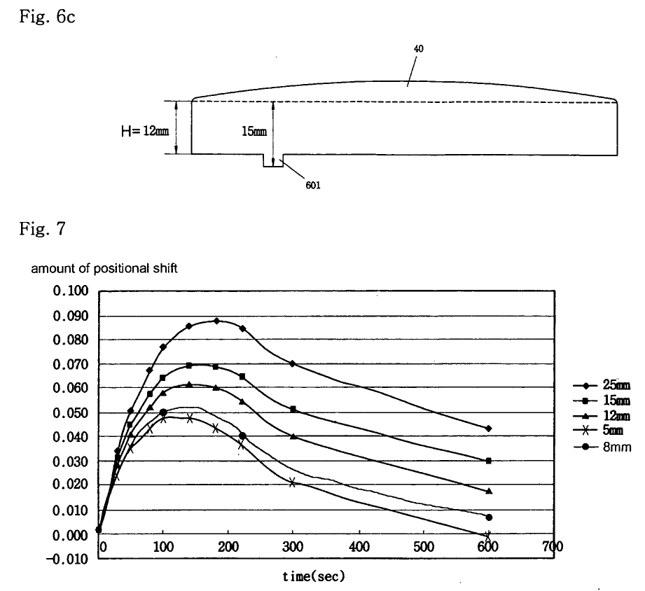

The inventor conducted experiments related to the height of the skirt portion in order to discover a size of the skirt portion by which the area of the part of the skirt portion opposite to the frame can be made as small as possible. The height of the overall skirt portion was varied. FIGS. 6a and 6b show a side view of the mask-frame assembly to illustrate an example of the skirt portions having relatively long and short heights respectively. As shown in FIGS. 6a and 6b, as the height H of the skirt portion decreases, the height Ho of the part of the skirt portion which is opposite to the frame decreases accordingly.

Table 1 shows the result of an experiment wherein a landing error was measured for various shadow masks having skirt portions of various heights. FIG. 7 shows a graph illustrating the results in Table 1.

TABLE 1

| | | Item | | | | |
|---|---|---|---|---|---|---|
| | | Height of the skirt portion(mm) | | | | |
| | | Background Art | | The Present Invention | | |
| Time (sec) | | 25 | 15 | 12 | 8 | 5 |
| 1 | Amount of | 0.002 | 0.002 | 0.002 | 0.002 | 0.002 |
| 30 | Landing | 0.034 | 0.031 | 0.029 | 0.026 | 0.025 |
| 50 | Error | 0.050 | 0.045 | 0.041 | 0.037 | 0.035 |
| 80 | | 0.067 | 0.058 | 0.053 | 0.046 | 0.044 |
| 100 | | 0.077 | 0.064 | 0.058 | 0.050 | 0.047 |
| 140 | | 0.085 | 0.069 | 0.062 | 0.051 | 0.048 |
| 180 | | 0.087 | 0.069 | 0.060 | 0.047 | 0.044 |
| 220 | | 0.084 | 0.065 | 0.055 | 0.040 | 0.037 |
| 300 | | 0.070 | 0.051 | 0.040 | 0.032 | 0.021 |
| 600 | | 0.043 | 0.029 | 0.017 | 0.008 | -0.001 |

As shown in Table 1 and FIG. 7, as the height H of the skirt portion decreases, the height Ho of the part of the skirt portion which is opposite to the frame decreases accordingly. Consequently, heat transfer from the shadow mask to the frame decreases, and, therefore a landing error of the electron beam decreases. According to the result of the experiment shown Table 1 and FIG. 7, a landing error of the electron beam was remarkably decreased when the height of the skirt portion was less than or equal to 12 mm. When the height of the skirt portion is less than or equal to 12 mm, a height of the part of the skirt portion which is opposite to the frame becomes less than or equal to 10 mm. Consequently, when a height of the part of the skirt portion which is opposite to the frame is less than or equal to 10 mm, a landing error of the electron beam is remarkably reduced.

In other words, if the height is less than or equal to 12 mm for the substantially entire skirt portion, a landing error problem can be remarkably reduced. FIG. 6c shows a side view of a modified version of the first embodiment presented above. As shown in FIG. 6c, the skirt portion can have a protrusion 601 by which the height of the skirt portion including the protrusion 601 exceeds 12 mm. However, other areas of the skirt portion are still equal to, or less than 12 mm. Although a protrusion is formed at the skirt portion, the effect of reducing a landing error can still be achieved. This is because the area of the protrusion is negligible with respect to the overall area of the skirt portion. Therefore, the modified embodiment of FIG. 6c is within the scope of the present invention.

If the height H of at least 65% of the overall skirt portion at a long side of the faceplate portion of the shadow mask is less than or equal to 12 mm, a landing error can be avoided to the same extent as the above-mentioned embodiment. Also, if the height H of at least 60% of the overall skirt portion at a short side of the faceplate portion of the shadow mask is less than or equal to 12 mm, a landing error can also be avoided to the same extent as the above-mentioned embodiment. These modifications to the embodiment can also achieve the effect that landing error is reduced remarkably by decreasing heat transfer between the mask and the frame.

FIG. 5b shows a plane view of a shadow mask in accordance with the present invention. Referring to FIG. 5b, the first embodiment (presented above) can be modified such that the shadow mask is improved by changing the area of the skirt portion with respect to the faceplate portion of the shadow mask. Here, the faceplate portion refers to a front face side of the shadow mask which includes the apertured portion and the border portion of the shadow mask. When the ratio of the areas of the faceplate portion to the skirt portion of the shadow mask is not less than d²/(d+24)² and no greater than 1, wherein d is the diagonal length of the faceplate portion of the shadow mask, it was found that the heat transfer from the shadow mask to the frame is remarkably reduced. A landing error of the electron beams is reduced accordingly.

According to a modified version of the first embodiment of the present invention, in addition to reducing a height of the skirt portion or limiting the height to an appropriate range, holes are perforated at the skirt portion. With the holes, heat transfer from the shadow mask to the frame can be reduced even further. Accordingly, a landing error of the electron beams can also be remarkably reduced. According to another version of the first embodiment, the holes may have various shapes, e.g., circular, elliptical, or a rectangular shape. According to a further modified version of the first embodiment, the holes may be opened to the rearward direction from the front face side of the shadow mask. Further, the holes may be perforated at the part of the skirt portion which is opposite to the frame.

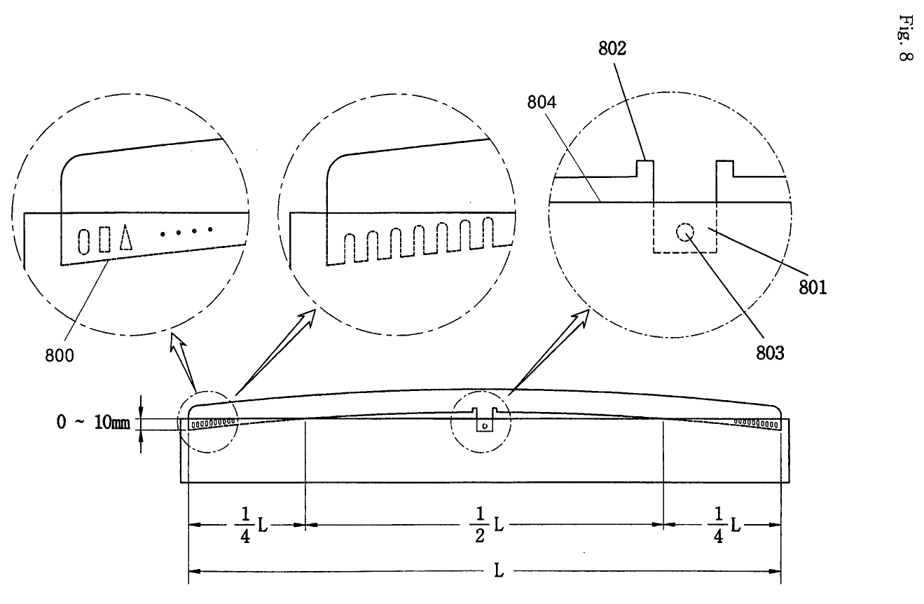

According to another modified version of the first embodiment, an edge line 800 of the skirt portion curves toward the front face side of the shadow mask. Therefore, the edge line bends toward the front face of the shadow mask as it is near the central portion of the edge line. FIG. 8 shows a side view of the shadow mask in accordance with this modified version of. As shown in FIG. 8, a maximum of the height of the part of the skirt portion which is opposite to the frame is no greater than 10 mm. Additionally, the edge line of the skirt portion curves toward the front face of the shadow mask. Therefore, the area of the part which is opposite to the frame can be reduced further in comparison to an embodiment wherein only the height of the skirt portion is reduced.

Since the edge line curves toward the front face side, the part of the skirt portion which is opposite to the frame has a maximum height at the corner of the faceplate. The portion opposite to the frame becomes shorter as it nears the center of the skirt portion. At a central part of the skirt portion, the part which is opposite to the frame does not exist. Preferably, a length of the edge line of the skirt portion, which is a greater distance away from the front face side than the edge line 804 of the frame, is no greater than ½ of the overall length of the edge line.

Since the edge line 800 curves toward the front face side, the central portion of the edge line is closer to the front face side than the edge line 804 of the frame. In this case, the skirt portion may have a protrusion 801 having a welding point 803 at which to weld the frame. FIG. 8 shows a side view of the shadow mask where the skirt portion has a protrusion. This protrusion may be provided instead of, or in addition to welding points at four corners of the shadow mask. With the protrusion 801, it is possible to further reduce the height of the portion of the skirt portion which is opposite to the frame. Moreover, it is possible to prevent the welding points at four corners of the shadow mask from becoming a source of binding when the mask expands. Therefore, a landing error problem is reduced even further.

According to still another modified version of the first embodiment, a notch 802 is cut at an edge of the protrusion 801. By providing the notch 802, it is possible to further reduce the extent that the welding point at the protrusion 801 acts as a source of binding against thermal expansion of the shadow mask. Accordingly, an amount of landing error is further diminished.

For each version of the first embodiment described hereinabove, even when the shadow mask is made of AK material a landing error is still remarkably reduced in comparison with the prior art.

Further, an electron beam reflective material may be coated on the back plate surface of the shadow mask on which the electrons impinge. With the reflective material, heat generation due to impingement of electron beams is reduced. Therefore, a temperature elevation of the shadow mask is reduced and, accordingly, a landing error is further reduced.

Further, each of the embodiments described hereinabove may be applied to a flat type color cathode ray tube in which an outer surface of the panel is substantially flat. Therefore, the present invention is still effective for a flat type color cathode ray tube.

### Second Embodiment

According to another aspect of the present invention, a color cathode ray tube comprising a panel having a phosphor screen formed on an inner surface thereof, a shadow mask having a faceplate portion and a peripheral skirt portion bent back from the faceplate portion and a frame joined to the skirt portion of the shadow mask is provided, wherein height of the skirt portion is less than or equal to 12 mm for substantially entire skirt portion, and a plurality of holes are perforated at the skirt portion of a short side of the faceplate portion.

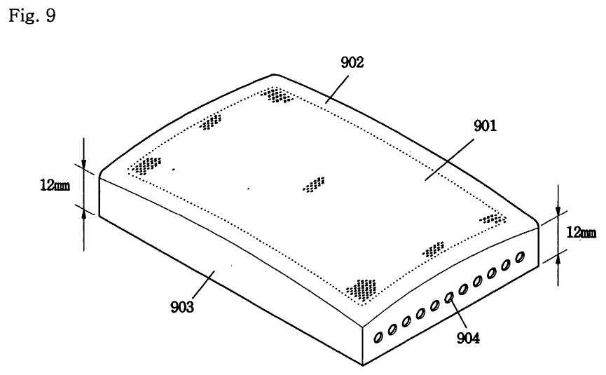

FIG. 9 shows a perspective view of a shadow mask in accordance with a second embodiment of the present invention.

As shown in FIG. 9, the shadow mask in accordance with the second embodiment of the present invention comprises a faceplate portion and a peripheral skirt portion bent back from the faceplate portion and extending backward from the faceplate portion. The faceplate portion further comprises an apertured portion 901 where minute apertures through which electron beams pass are defined and a non-apertured border portion 902 surrounding the apertured portion 901. The skirt portion comprises long side skirt portion 903 and short side skirt portion 904.

According to the second embodiment, height of the skirt portion 903 and 904 at both the long and short sides is 12 mm or below and holes are perforated only at the short side skirt portion 904. By making the skirt portion to be no greater than 12 mm and perforating holes at the short side skirt portion, it is possible to reduce heat transfer from the skirt portion to the frame such that landing error due to non-uniform thermal expansion of the shadow mask is suppressed. Further, by perforating the holes only at the short side, landing error due to the terrestrial magnetism may also be suppressed.

For the second embodiment, the modifications made to the first embodiment as described above may also be applied. Such modifications include: curving the end line of the skirt portion; limiting area of the part in the skirt portion which is not opposite to the frame; providing protrusions; providing a notch adjacent to a protrusion; modifying shape of the holes at the skirt portion; and providing the holes at the part of the skirt portion which is opposite to the frame. Detailed description of such modifications should be referred to that of the first embodiment.

The second embodiment may further include such modifications as the use of AK material for the shadow mask; coating material which is reflective against electron beam on the inner surface of the shadow mask; and making the front face of panel to be substantially flat.

As described hereinabove, the present invention achieves a reduction of a landing error of an electron beam, which is caused by non-uniform thermal expansion of a shadow mask.

Further, according to the present invention, AK material may be used instead of invar material. Since AK material is not expensive in comparison with invar material, the overall cost for making a shadow mask is reduced.

Further, according to the present invention, landing error of electron beams caused by the terrestrial magnetism can be suppressed such that color purity is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A color cathode ray tube comprising:
a panel having a phosphor screen formed on an inner surface thereof;
a shadow mask having a faceplate portion and a skirt portion bent back from the faceplate portion; and
a frame joined to the skirt portion of the shadow mask, wherein a height of the skirt portion at a long side of the faceplate portion is different from a height of the skirt portion at a short side of the faceplate portion, and a plurality of holes are perforated at the skirt portion of a short side of the faceplate portion.

2. The color cathode ray tube of claim 1, wherein a height of the skirt portion is less than or equal to 12 mm for substantially the entire skirt portion

3. The color cathode ray tube of claim 1, wherein said holes are located at part of said skirt portion which is not opposite to said frame.

4. The color cathode ray tube of claim 3, wherein said holes are perforated at a part of the skirt portion which is opposite to the frame.

5. The color cathode ray tube of claim 1, wherein the height of the skirt portion at the long side of the faceplate portion is greater than the height of the skirt portion at the short side of the faceplate portion.

6. The color cathode ray tube of claim 1, wherein an edge line of said skirt portion curves toward a front face side of said shadow mask.

7. The color cathode ray tube of claim 6, wherein a length of the edge line of said skirt portion, which is farther from the front face side than the edge line of said frame is less than or equal to ½ of the overall length of the edge line of said skirt portion.

8. The color cathode ray tube of claim 1, wherein said skirt portion includes a protrusion having a welding point at which to weld said frame.

9. The color cathode ray tube of claim 8, wherein a notch is cut at an edge of said protrusion.

10. The color cathode ray tube of claim 1, wherein said plurality of holes are opened to a rearward direction from a front face side of said shadow mask.

11. The color cathode ray tube of claim 1, wherein said shadow mask is made of aluminum killed material.

12. The color cathode ray tube of claim 1, wherein an electron beam reflective material is coated on a back plate surface of said shadow mask.

13. The color cathode ray tube of claim 1, wherein an outer surface of said panel is substantially flat.

14. The color cathode ray tube of claim 1, wherein at least 65% of the overall skirt portion at a long side of the faceplate portion of said shadow mask is less than or equal to 12 mm.

15. The color cathode ray tube of claim 1, wherein at least 60% of the overall skirt portion at a short side of the faceplate portion of the shadow mask is less than or equal to 12 mm.

16. The color cathode ray tube of claim 1, wherein a ratio of areas of the faceplate portion to the skirt portion of the shadow mask is not less than d²/(d+24)² and no greater than 1, wherein d is the diagonal length of the faceplate portion of the shadow mask.

17. The color cathode ray tube of claim 1, wherein a maximum length of a part of said skirt portion which is opposite to said frame is less than or equal to 10 mm.

18. A color cathode ray tube comprising:
a panel having a phosphor screen formed on an inner surface thereof;
a shadow mask having a faceplate portion and a skirt portion bent back from the faceplate portion; and
a frame joined to the skirt portion of the shadow mask, wherein height of the skirt portion is less than or equal to 12 mm for substantially entire skirt portion, and a plurality of holes are perforated at the skirt portion of a short side of the faceplate portion.

19. The color cathode ray tube of claim 18, wherein said holes are located at part of said skirt portion which is not opposite to said frame.

20. The color cathode ray tube of claim 18, wherein said holes are perforated at a part of the skirt portion which is opposite to the frame.

21. The color cathode ray tube of claim 18, wherein the height of the skirt portion at the long side of the faceplate portion is greater than the height of the skirt portion at the short side of the faceplate portion.

22. The color cathode ray tube of claim 18, wherein an edge line of said skirt portion curves toward a front face side of said shadow mask.

23. The color cathode ray tube of claim 22, wherein a length of the edge line of said skirt portion, which is farther from the front face side than the edge line of said frame is less than or equal to ½ of the overall length of the edge line of said skirt portion.

24. The color cathode ray tube of claim 18, wherein said skirt portion includes a protrusion having a welding point at which to weld said frame.

25. The color cathode ray tube of claim 24, wherein a notch is cut at an edge of said protrusion.

26. The color cathode ray tube of claim 18, wherein said hole is opened to a rearward direction from a front face side of said shadow mask.

27. The color cathode ray tube of claim 18, wherein said shadow mask is made of aluminum killed material.
